(19) United States
(12) Patent Application Publication
(10) Pub. No.: US 2023/0243386 A1
(43) Pub. Date: Aug. 3, 2023

(54) HINGE MECHANISM WITH COLLAPSIBLE LEG

(71) Applicant: Mark T. Miller, Santa Monica, CA (US)

(72) Inventor: Mark T. Miller, Santa Monica, CA (US)

(21) Appl. No.: 18/103,636

(22) Filed: Jan. 31, 2023

Related U.S. Application Data
(60) Provisional application No. 63/305,857, filed on Feb. 2, 2022.

(51) Int. Cl. F16C 11/04; F16M 11/38; B25H 1/04

(52) U.S. Cl. CPC F16C 11/04; F16M 11/38; B25H 1/04

(57) ABSTRACT

A hinge mechanism with a collapsible leg is disclosed. The hinge mechanism may include a support member with a first end and a second end. The first end may be configured to be rotationally coupled to a first portion of a frame via a first rotational coupling. The second end may be rotationally coupled to the collapsible leg via a second rotational coupling. The collapsible leg may be configured to move between an extended position and a collapsed position. The collapsible leg may include a mating surface at a first leg end. The mating surface may be configured to be removably mateable to a corresponding mating surface of a second portion of the frame when in the extended position.

### CROSS-REFERENCE TO RELATED APPLICATION

The present application claims the benefit under 35 U.S.C. § 119(e) of U.S. Provisional Patent Application Ser. No. 63/305,857, filed on Feb. 2, 2022, entitled WORKBENCH AND ACCESSORIES, which is incorporated herein by reference in the entirety.

### TECHNICAL FIELD

The present disclosure relates generally to hinges and collapsible tables and, more particularly, to a hinge mechanism including one or more collapsible legs.

### BACKGROUND

Work tables are commonly used in a variety of applications, such as in job sites, workshops, offices, schools, and homes. These tables are typically heavy-duty, constructed with a rigid frame, and designed to support a large amount of weight. The legs of the table are typically connected to the frame with strong and sturdy fasteners, such as screws, bolts, or rivets.

However, work tables are not always the most convenient when it comes to transport and storage, such as when moving them from one place to another. Additionally, the legs of the table may take up a lot of space when the table is not in use, making it difficult to store the table in a compact form.

Collapsible tables have been in use for some time. For example, U.S. Pat. No. 2,784,042, issued Mar. 5, 1957, discloses a table with detachable struts that allow the legs to swing up under the table top.

However, collapsible tables typically have some drawbacks. For example, the legs may be permanently and rotationally coupled to the table top, which may limit the length of the legs and make it difficult to transport the table in a compact form. Additionally, the pivoting mechanism may need to be strong and relatively expensive to support the weight of the table and any material and forces applied to the table.

Thus, there is a need for a work table that is both sturdy and able to be easily transported and stored.

### SUMMARY

A hinge mechanism with a collapsible leg is disclosed in accordance with one or more illustrative embodiments of the present disclosure. In one illustrative embodiment, the hinge mechanism may include a support member with a first end and a second end. In another illustrative embodiment, the first end may be configured to be rotationally coupled to a first portion of a frame via a first rotational coupling. In another illustrative embodiment, the second end may be rotationally coupled to the collapsible leg via a second rotational coupling. In another illustrative embodiment, the collapsible leg may be configured to move between an extended position and a collapsed position. In another illustrative embodiment, the collapsible leg may include a mating surface at a first leg end. In another illustrative embodiment, the mating surface may be configured to be removably mateable to a corresponding mating surface of a second portion of the frame when in the extended position.

A work table is disclosed in accordance with one or more illustrative embodiments of the present disclosure. In one illustrative embodiment, the work table may include a frame, a support member, and a collapsible leg. In another illustrative embodiment, the support member may include a first end and a second end. In another illustrative embodiment, the first end may be configured to be rotationally coupled to a first portion of the frame via a first rotational coupling. In another illustrative embodiment, the second end may be rotationally coupled to the collapsible leg via a second rotational coupling. In another illustrative embodiment, the collapsible leg may be configured to move between an extended position and a collapsed position. In another illustrative embodiment, the collapsible leg may include a mating surface at a first leg end. In another illustrative embodiment, the mating surface may be configured to be removably mateable to a corresponding mating surface of a second portion of the frame when in the extended position.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A is a work table with collapsible legs in an extended position, in accordance with one or more embodiments of the present disclosure.

FIG. 1B is an enlarged view of the work table illustrating a stop, in accordance with one or more embodiments of the present disclosure.

FIG. 1C is a collapsible leg of the work table illustrated in a position that is between the extended position and the collapsed position, in accordance with one or more embodiments of the present disclosure.

FIG. 2 is a collapsible leg in the collapsed position, in accordance with one or more embodiments of the present disclosure.

FIG. 3A is an enlarged view of a hinge locking pin that is spring loaded and configured to lock the collapsible leg in place, in accordance with one or more embodiments of the present disclosure.

FIG. 3B is an enlarged view of a hinge locking pin that is spring loaded and configured to lock the collapsible leg in place when the collapsible leg is in the collapsed position, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to a hinge mechanism including a collapsible leg with a mating surface at one end configured to allow the collapsible leg to be removably mated to a corresponding mating surface.

In some conventional tables, the tables include a strut member, and the strut member may uncouple/detach from the table top to allow the legs to fold under the table. The legs are permanently and rotationally coupled to the table top and as the strut is uncoupled on one end, legs become free to rotate up under the table. For example, such a table is disclosed in U.S. Pat. No. 2,784,042, issued Mar. 5, 1957 with detachable struts that allow for the legs to swing up under the table top. However, at least a few issues may exist with such a design, especially if a taller and stronger table is desired, such as a work table.

First, one issue with using permanently pivoting leg locations at an offset distance from the ends of the table as shown in U.S. Pat. No. 2,784,042 is that either shorter legs must be used or else the legs will overlap or interfere with each other. Using a permanently pivoting leg location at an offset distance from the table ends means the legs are shorter when folded up in their collapsed positions because they would need to be pivoting from the very end of the table to maximize the available length of the table. In some embodiments of the present disclosure, using a detachable coupling between the legs and the table top allows for maximum leg length without needing to overlap the legs—even when the legs are offset from the table ends. The table legs may couple at an offset distance from the table ends when in the extended position and at or near the table ends when in the collapsed position.

A second issue with legs being permanently pivoted to the table top is that the pivoting mechanism may need to be strong and therefore relatively costly to support the entire weight of the table and any material and forces applied to the table. The pivoting mechanism may need to maintain operation, lubrication, and/or integrity over a wide range of forces, temperatures, and lifetime of the product. It is contemplated herein that rather than a pivoting mechanism, a mating connection between the legs and the table top may provide a stronger and more reliable support. For example, the mating connection could be a bracing foot style connection. The mating connection may improve reliability, simplicity, affordability, and/or the like compared to a pivoting mechanism. The support member is likely going to experience smaller loads compared to the legs and therefore not need as strong and expensive of a rotational coupling. Further, a mating connection (e.g., bracing foot) may provide for less backlash/wiggle than a pivoting mechanism. In this regard, a worktable with a mating connection may be more sturdy and rigid, which may aide in practical activities such as precise alignment of work product on the work table.

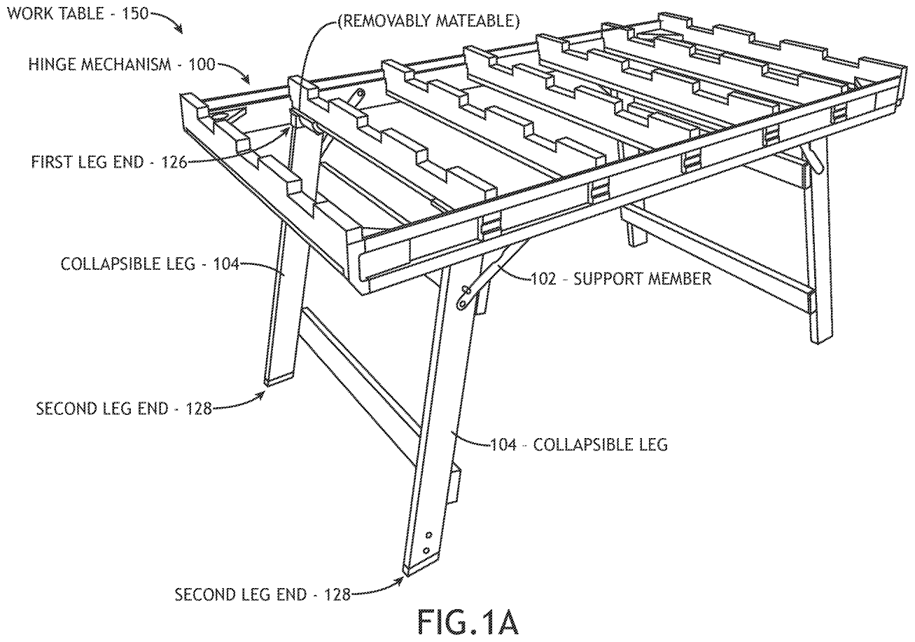

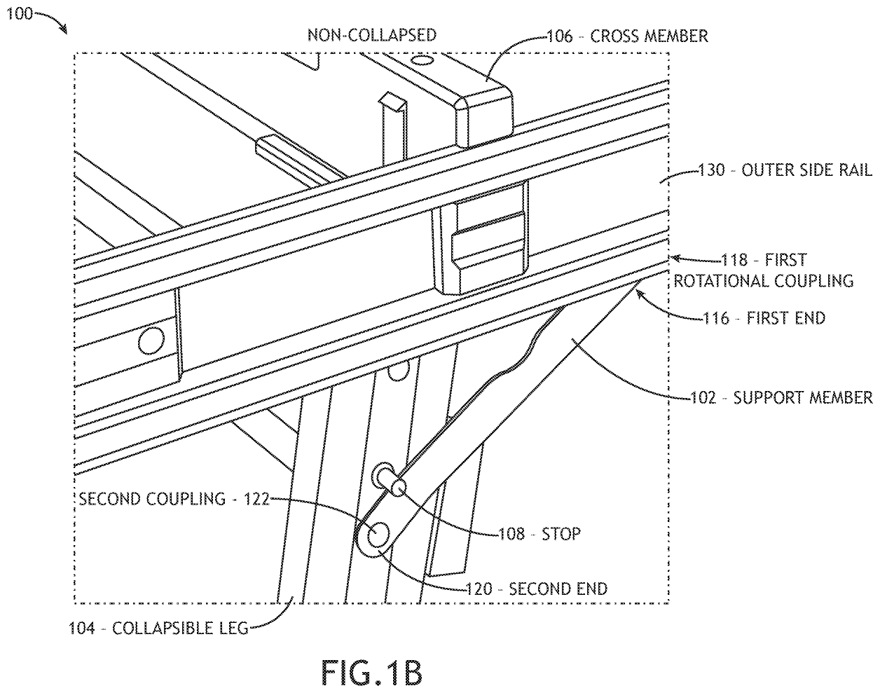

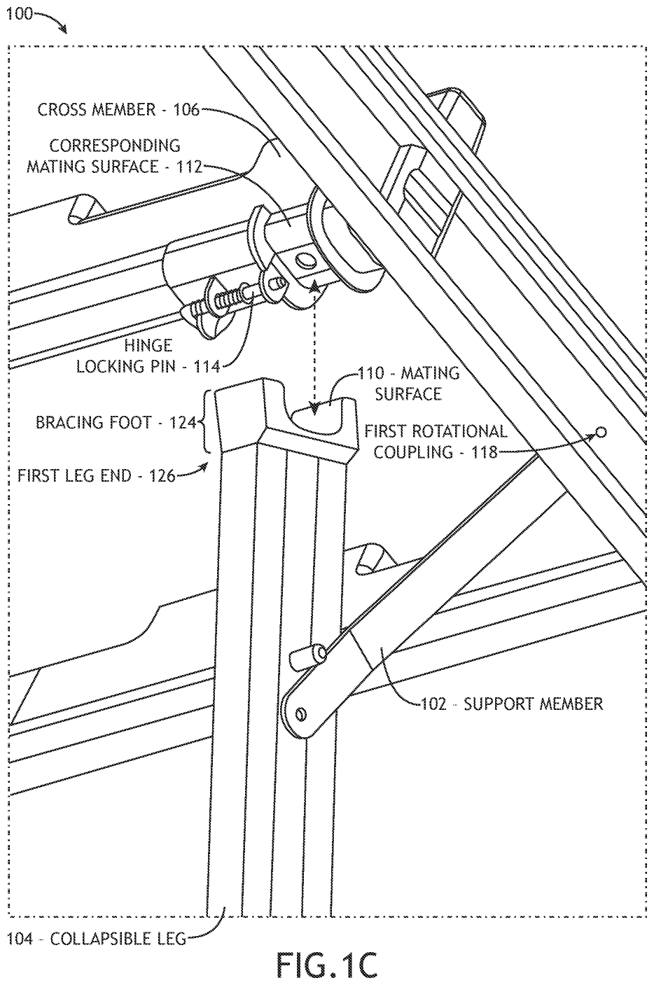

FIG. 1A is a work table 150 including a hinge mechanism 100 in an extended position, in accordance with one or more embodiments of the present disclosure.

The present disclosure may be, in some ways, an improvement to the work table of U.S. Pat. No. 8,727,327, or at least potentially applicable in one or more respects. In one or more embodiments, the work table and/or outer side rail of the present disclosure includes one or more components, configurations, functionality, materials, and/or the like as disclosed by the work table and/or elongated members in U.S. Pat. No. 8,727,327, issued May 20, 2014, which is herein incorporated by reference in the entirety.

In some embodiments, the hinge mechanism 100 is configured to be used with a work table 150. The work table 150 may include a frame such as, but not necessarily limited to, a table top. For example, the frame may be a table top that includes cross members and outer side rails as shown.

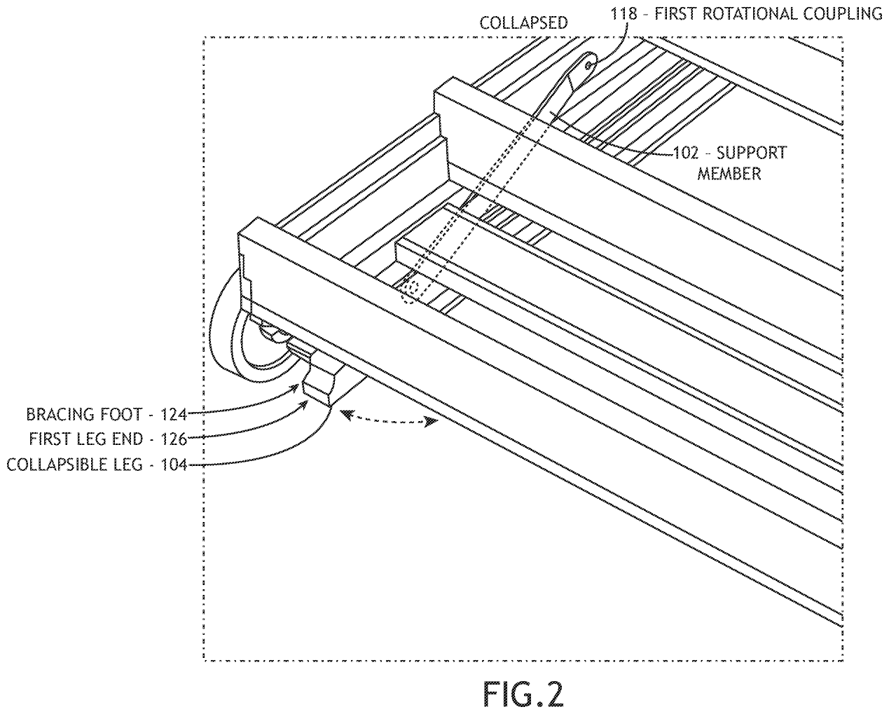

The hinge mechanism 100 includes one or more support members 102 and one or more collapsible legs 104. The hinge mechanism 100 is configured to allow a collapsible leg 104 to move between the extended position (e.g., see FIG. 1A) and a collapsed position (e.g., see FIG. 2).

It is noted that the hinge mechanism 100 may include any number of the components described herein. For example, the hinge mechanism 100 may include two support members 102, two collapsible legs 104, and the like. Further, as shown, the two collapsible legs 104 may be coupled to each other such that they move together. Moreover, the work table 150 may include two sets of two collapsible legs 104, one set on each side, symmetrically distributed and configured to fold inwards. Each set may be configured to couple to the frame at an offset distance from the end (e.g., the shorter end) of the work table 150 when positioned in their respective extended positions.

The collapsible leg 104 includes a mating surface at a first leg end 126. For an example illustration of a mating surface, see mating surface 110 of FIG. 1C. The mating surface 110 is configured to be removably mateable to a corresponding mating surface 112 (see FIG. 1C) of a second portion of the frame when in the extended position. For instance, the corresponding mating surface 112 may be a portion of the cross member 106 of the frame. In some embodiments, the cross member 106 is perpendicular relative to the collapsible leg 104 as shown. In this regard, the collapsible leg 104 may be swung up and rotated so that the mating surface 110 aligns with, couples with, and mates with, the corresponding mating surface 112, forming a strong and sturdy structure.

FIG. 1B is an enlarged view of the work table 150 of FIG. 1A illustrating a stop 108 and the support member 102, in accordance with one or more embodiments of the present disclosure. The stop 108 may aide in properly aligning the mating surface 110.

The support member 102 includes a first end 116 opposite a second end 120. The first end 116 is configured to be rotationally coupled to a first portion of the frame via a first rotational coupling 118 (see FIG. 1C for an alternate view of the first rotational coupling 118). For example, the first portion may be a portion of an outer side rail 130 of the frame. The second end 120 is rotationally coupled to the collapsible leg 104 via a second rotational coupling 122.

In embodiments, the support member 102 may be any dimension. For example, the support member may be an inch wide (or less).

The stop 108 may be a positioned in any location that allows for limiting a range of motion of the second rotational coupling 122 to aide in alignment of the mating surface 110 of the collapsible leg 104 to the corresponding mating surface 112. In this regard, an over-rotation of the collapsible leg 104 may be prevented, allowing for quick alignment. For example, one location of the stop 108 is the collapsible leg 104. Another location (not shown) is the support member 102.

The stop 108 may include (or be) a protrusion configured to provide the limit to the range of rotation by virtue of a contact between the protrusion and the support member 102 or the like. The protrusion may include, but is not necessarily limited to, a pin and/or a bolt.

FIG. 1C is a collapsible leg 104 illustrated in a position that is between the extended position and the collapsed position, in accordance with one or more embodiments of the present disclosure. As shown, the corresponding mating surface 112 may be a portion of a cross member 106. The corresponding mating surface 112 may be, but is not necessarily limited to, a portion of a tubular structure (e.g., steel tube, plastic tube).

In some embodiments, the collapsible leg 104 may include a bracing foot 124. For example, the bracing foot 124 may be at the first leg end 126 and include the mating surface 110 as shown.

In embodiments, the bracing foot 124 and/or mating surface 110 may at least partially enclose, face, and/or mate with two internally facing sides of the second portion of the frame as shown. For example, the bracing foot 124 and/or mating surface 110 may be cup shaped and/or C-shaped. In this regard, the bracing foot 124 and/or mating surface 110 may provide side support and a stronger connection than just a flat surface pushing on another flat surface. The cup and/or C-shape may allow for a stronger connection that resists side forces that may otherwise cause a sliding of the mating surface 110.

In embodiments, as shown, a hole (not labeled but shown in FIG. 1C) in the corresponding mating surface 112 may be configured to receive a mating protrusion (not shown) of the mating surface 110. In this regard, the mating protrusion of the mating surface 110 may be inserted into the hole to aide in alignment and/or support. The mating protrusion may be tapered to aide in insertion.

In embodiments, the support member 102 is configured to fit between the outer side rail 130 and the collapsible leg 104.

FIG. 2 is the collapsible leg 104 in the collapsed position, in accordance with one or more embodiments of the present disclosure. As shown, the collapsed position may be up under the frame (e.g., table top) of the work table 150 such that the collapsible leg 104 is substantially parallel (e.g., within 10 degrees) with the table top. In this regard, the hinge mechanism 100 allows for portable and compact storage.

Illustrated to the left of the bracing foot 124 is a rotationally coupled wheel. In embodiments, one wheel may be symmetrically located on each side of the work table 150. For example, each wheel may extend past and/or below the collapsible leg 104 to allow for rolling the work table 150 on the ground. For example, the work table may be heavier than other portable tables, and wheels may allow for ease of portability of the work table 150 when in a collapsed position. The wheels may be mounted anywhere, such as to the outer side rail 130 as shown, the end rail, and/or the like.

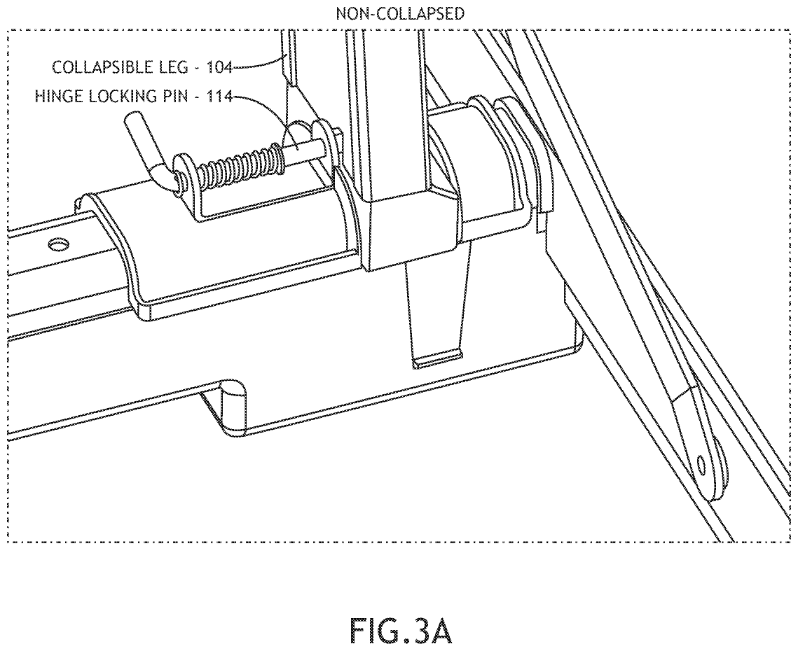

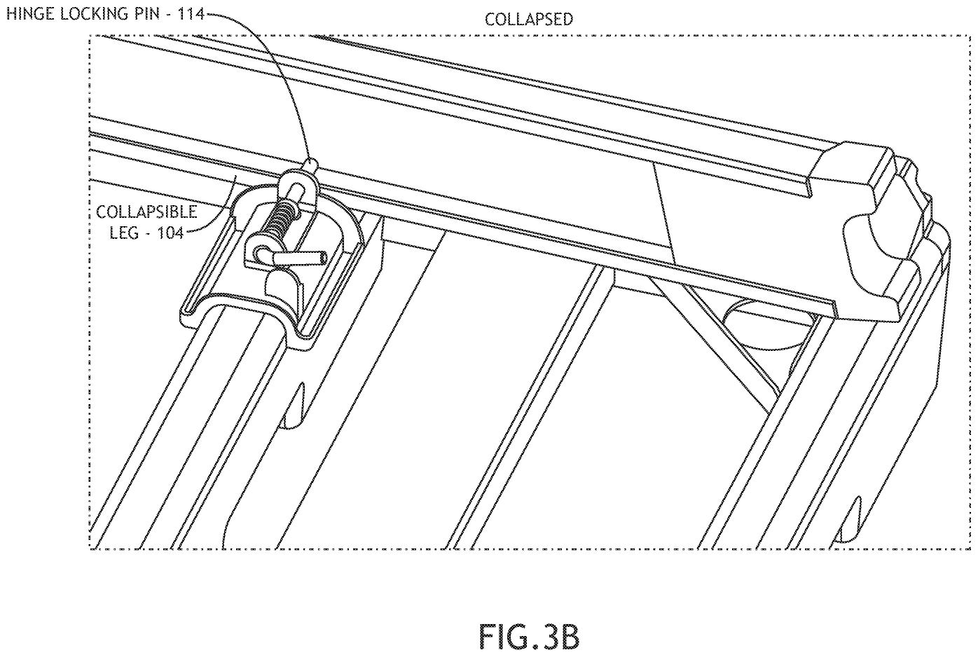

FIG. 3A is an enlarged view of a hinge locking pin 114, in accordance with one or more embodiments of the present disclosure.

In some embodiments, the hinge locking pin 114 is spring loaded and/or configured to lock the collapsible leg 104 in place when the mating surface 110 is mated to the corresponding mating surface 112. For example, a sloped surface may engage the pin against a spring as the collapsible leg 104 is put in place until a void (e.g., hole) of the collapsible leg is aligned with the pin, thereby automatically snapping the pin into place using the spring. In other embodiments, a user may pull the pin back against the spring until the collapsible leg 104 is in place, and release the pin to lock the collapsible leg 104. Once locked, the collapsible leg 104 may generally be unlocked by pulling (or the like) the pin back, and removing the collapsible leg 104.

FIG. 3B is an enlarged view of a hinge locking pin 114 that is spring loaded and configured to lock the collapsible leg 104 in place when the collapsible leg 104 is in the collapsed position, in accordance with one or more embodiments of the present disclosure. In this regard, as shown, the same hinge locking pin 114 may be dual-use, and configured to lock the collapsible leg 104 in more than one position.

As shown, the hinge locking pin 114 may engage with an inside facing surface of a mid-portion of the collapsible leg 104.

For purposes of the present disclosure, a “rotational coupling” (e.g., first rotational coupling, second rotational coupling) generally refers to a mechanical connection between two components that allows for rotational movement of one component relative to the other. Examples of rotational couplings include, but are not limited to, axels generally; bushings with an axle such as a bolt, pin, or the like; ball-joints; bolts with lock nuts to allow for rotational sliding between components; bearings; and/or other fasteners.

Referring again generally to FIGS. 1A-3B, it is to be understood that FIGS. 1A-3B are provided solely for illustrative purposes and should not be interpreted as limiting. Rather, a hinge mechanism may generally provide various structure and functions for operation as any type of hinge. In this way, the illustrations and examples referring to operation in the context of a collapsible leg are merely illustrations. Further, the illustrations and examples referring to the particular components (e.g., the support member and the collapsible leg) are also merely illustrations. It is contemplated herein that a hinge mechanism 100 as disclosed herein may comprise any number or type of components based on selective use of associated components to a frame and the collapsible leg.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A hinge mechanism with a collapsible leg, the hinge mechanism comprising:
a support member comprising a first end opposite a second end, wherein the first end is configured to be rotationally coupled to a first portion of a frame via a first rotational coupling and the second end is rotationally coupled to the collapsible leg via a second rotational coupling; and
the collapsible leg configured to move between an extended position and a collapsed position,
wherein the collapsible leg comprises a mating surface at a first leg end, wherein the mating surface is configured to be removably mateable to a corresponding mating surface of a second portion of the frame when in the extended position.

2. The hinge mechanism of claim 1, wherein the corresponding mating surface is a portion of a cross member of the frame.

3. The hinge mechanism of claim 2, wherein the cross member is perpendicular relative to the collapsible leg.

4. The hinge mechanism of claim 1, wherein the hinge mechanism further includes a stop configured to provide a limit to a range of rotation of the second rotational coupling of the collapsible leg to aide in alignment of the mating surface of the collapsible leg to the corresponding mating surface.

5. The hinge mechanism of claim 4, wherein the collapsible leg comprises the stop, wherein the stop includes a protrusion configured to provide the limit to the range of rotation by virtue of a contact between the protrusion and the support member.

6. The hinge mechanism of claim 5, wherein the protrusion includes at least one of a pin or bolt.

7. The hinge mechanism of claim 1, wherein the collapsible leg further comprises a bracing foot at the first leg end, wherein the bracing foot includes the mating surface.

8. The hinge mechanism of claim 1 further comprising a hinge locking pin configured to lock the collapsible leg in place when the mating surface is mated to the corresponding mating surface.

9. The hinge mechanism of claim 8, wherein the hinge locking pin is spring loaded.

10. The hinge mechanism of claim 1, wherein the first portion of the frame is an outer side rail.

11. The hinge mechanism of claim 10, wherein the support member is configured to fit between the outer side rail and the collapsible leg in the collapsed position.

12. A hinge mechanism as in claim 1, wherein the support member is an inch wide.

13. A work table comprising:
a frame; and
a hinge mechanism, the hinge mechanism comprising:
a support member comprising a first end opposite a second end, wherein the first end is configured to be rotationally coupled to a first portion of the frame via a first rotational coupling and the second end is rotationally coupled to a collapsible leg via a second rotational coupling; and
the collapsible leg configured to move between an extended position and a collapsed position,
wherein the collapsible leg comprises a mating surface at a first leg end, wherein the mating surface is configured to be removably mateable to a corresponding mating surface of a second portion of the frame when in the extended position.

14. The work table of claim 13, wherein the corresponding mating surface is a portion of a cross member of the frame.

15. The work table of claim 13, wherein the hinge mechanism further includes a stop configured to provide a limit to a range of rotation of the second rotational coupling of the collapsible leg to aide in alignment of the mating surface of the collapsible leg to the corresponding mating surface.
